(19) United States
(12) Patent Application Publication
(10) Pub. No.: US 2009/0054139 A1
(43) Pub. Date: Feb. 26, 2009

(54) Method Of Displaying Performance Data, A Performance Manager And A Performance Management System

(75) Inventor: Phillip Jeffery Anderson, Las Vegas, NV (US)

Correspondence Address: MCANDREWS HELD & MALLOY, LTD, 500 WEST MADISON STREET, SUITE 3400, CHICAGO, IL, 60661, US

(73) Assignee: Aristocrat Technologies Australia Pty. Limited, Lane Cove (AU)

(21) Appl. No.: 12/145,132

(22) Filed: Jun. 24, 2008

Related U.S. Application Data
(60) Provisional application No. 60/946,215, filed on Jun. 26, 2007.

(51) Int. Cl. G06F 17/00

(52) U.S. Cl. 463/31

(57) ABSTRACT

A method of displaying performance data in a gaming system, the method comprising: deriving at least one performance measure from at least one performance parameter of each of a plurality of gaming terminals; graphically representing the performance measure on a display; and displaying a representation of the performance of each gaming terminal relative to the graphically represented performance measure, the representation based on the at least one performance parameter of the gaming terminal.

### RELATED APPLICATIONS

This application claims priority to U.S. Provisional Patent Application No. 60/946,215, having a filing date of Jun. 26, 2007, entitled “A Method of Displaying Performance Data, A Performance Manager And A Performance Management System,” which is hereby incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### FIELD

The present invention relates to a method of displaying performance data, a performance manager and a performance management system for a gaming system.

### BACKGROUND TO THE INVENTION

Large gaming venues such as casinos typically have on their floor a large number of gaming machines that may be in operation simultaneously.

Recently it has been proposed to provide techniques for reconfiguring the gaming machines that are on a gaming floor, for example by using server based gaming to change the games that are downloaded onto a gaming terminal. In such an environment there is a need for tools to assist a person seeking to manage the configuration of gaming terminals to monitor the performance of a configuration.

### SUMMARY OF INVENTION

In a first aspect, the invention provides a method of displaying performance data in a gaming system, the method comprising:

deriving at least one performance measure from at least one performance parameter of each of a plurality of gaming terminals.

graphically representing the performance measure on a display; and

displaying a representation of the performance of each gaming terminal relative to the graphically represented performance measure, the representation based on the at least one performance parameter of the gaming terminal.

In an embodiment, the method further comprises displaying a floor configuration of the plurality of gaming machines such that the graphical representation of the performance measure is displayed in the context of the floor configuration.

In an embodiment, the method comprises displaying the floor configuration as a perspective view.

In an embodiment, the method comprises graphically representing the performance measure as a datum plane such that the performance of each gaming terminal is represented relative to the datum plane.

In an embodiment, the method comprises representing other information relative to each gaming terminal.

In an embodiment, the step of displaying a representation of the performance of each gaming terminal relative to the datum plane comprises displaying a performance indicator for each gaming terminal relative to the plane.

In an embodiment, the step of displaying a representation of the performance of each gaming terminal relative to the datum plane comprises displaying a representation of the gaming terminal relative to the datum plane to thereby represent the performance of each gaming terminal.

In an embodiment, each representation is linked to the display of the gaming machine in the floor configuration display of the plurality of gaming machines.

In an embodiment, the method comprises altering the floor configuration display of the plurality of gaming terminals so as to move the display of at least some of the gaming terminals relative to the datum plane.

In an embodiment, the method comprises deriving a value of a performance parameter for at least one of the plurality of gaming terminals from historical data for the performance parameter.

In an embodiment, the method comprises deriving a predicted value of a performance parameter for at least one of the plurality of gaming terminal.

In a second aspect the invention provides a performance manager for a gaming system arranged to:

derive at least one performance measure from at least one performance parameter of each of a plurality of gaming terminals;

generate a graphical representation of the performance measure for output to a display; and

generate a display of a representation of the performance of each gaming terminal relative to the graphically represented performance measure for output to the display, the representation based on the at least one performance parameter of the gaming terminal.

In an embodiment, the performance manager is further arranged to generate a display of a floor configuration of the plurality of gaming machines such that the graphical representation of the performance measure is displayed in the context of the floor configuration.

In an embodiment, the floor configuration is displayed as a perspective view.

In an embodiment, the performance measure is represented as a datum plane superimposed on the display of the floor configuration.

In an embodiment, the performance manager is arranged to display a performance indicator for each gaming terminal in order to represent the performance of each gaming terminal relative to the datum plane.

In an embodiment, the performance manager is arranged to display a representation of the machine relative to the datum plane in order to represent the performance of each gaming terminal relative to the datum plane.

In an embodiment, each representation is linked to the display of the gaming machine in the floor configuration display of the plurality of gaming machines.

In an embodiment, the performance manager is further arranged to alter the floor configuration display of the plurality of gaming terminals so as to move the display of at least some of the gaming terminals relative to the datum plane.

In an embodiment, the performance manager is arranged to derive a value of a performance parameter for at least one of the plurality of gaming terminals from historical data for the performance parameter.

In an embodiment, the performance manager is arranged to derive a predicted value of a performance parameter for at least one of the plurality of gaming terminals.

In an embodiment, the performance manager comprises a processor and a memory and is implemented, at least in part, by the processor executing program code stored in the memory.

In a third aspect of the invention provides performance management system for a gaming system comprising:

a display; and

a performance manager arranged to:

derive at least one performance measure from at least one performance parameter of each of a plurality of gaming terminals;

generate a graphical representation of the performance measure for display on the display; and

generate a display of a representation of the performance of each gaming terminal relative to the graphically represented performance measure, the representation based on the at least one performance parameter of the gaming terminal.

In an embodiment, the performance management system comprises a user interface arranged to allow a user to select at least one performance parameter from which the performance measure is to be derived.

In an embodiment the performance management system comprises a user interface arranged to allow a user to select a plurality of gaming terminals in relation to which the performance measure is to be derived.

In a fourth aspect, the invention provides a computer program code which when executed by a computer causes the computer to implement a computer implemented performance management method comprising:

deriving at least one performance measure from at least one performance parameter of each of a plurality of gaming terminals;

graphically representing the performance measure on a display; and

displaying a representation of the performance of each gaming terminal relative to the graphically represented performance measure, the representation based on the at least one performance parameter of the gaming terminal.

In an embodiment, the performance manager is further arranged to generate a display of a floor configuration of the plurality of gaming machines such that the graphical representation of the performance measure is displayed in the context of the floor configuration.

In an embodiment, the performance manager floor configuration is displayed as a perspective view.

In an embodiment, the performance measure is represented as a datum plane. In an embodiment, the datum plane is displayed in relation to a view (perspective, plan, elevation or other view) of the gaming floor including the components of the gaming floor such as the gaming machines, gaming tables, etc.

In an embodiment, the performance manager is further arranged to display a performance indicator for each gaming terminal in order to represent the performance of each gaming terminal relative to the datum plane where the datum plane may represent, for example, the casino floor average for a performance parameter for such terminals.

In an embodiment, the performance manager is further arranged to display a representation of the machine relative to the datum plane in order to represent the performance of each gaming terminal relative to the datum plane.

In an embodiment, each representation is linked to the display of the gaming machine in the floor configuration display of the plurality of gaming machines.

In an embodiment, the performance manager is further arranged to alter the floor configuration display of the plurality of gaming terminals so as to move the display of at least some of the gaming terminals relative to the datum plane.

In an embodiment, the performance manager is arranged to derive a value of a performance parameter for at least one of the plurality of gaming terminals from historical data for the performance parameter.

In an embodiment, the performance manager is to derive a predicted value of a performance parameter for at least one of the plurality of gaming terminal.

In an embodiment, the performance manager comprises a processor and a memory and implemented, at least in part, by the processor executing program code stored in the memory.

In fifth aspect the invention provides a computer readable medium having thereon the above computer program code.

In sixth aspect the invention extends to transmitting the above computer program code.

### BRIEF DESCRIPTION OF THE DRAWINGS

FIG. 1 illustrates a casino network system of an embodiment of the invention;

FIG. 2 illustrates detail of the functional components of a slot floor configuration manager that relate to performance management;

FIG. 3 is an exemplary user interface;

FIG. 4 is an exemplary display; and

FIG. 5 is a flow chart of an embodiment.

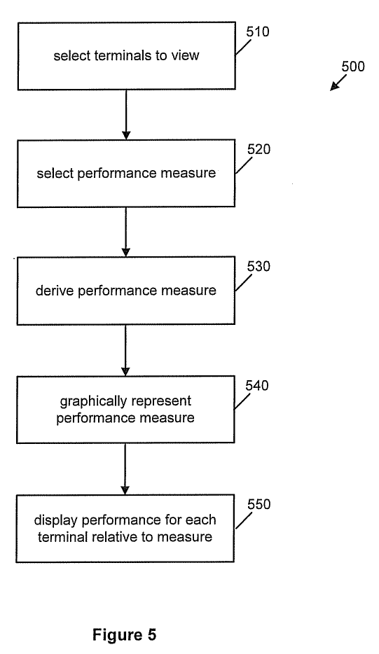

### DETAILED DESCRIPTION

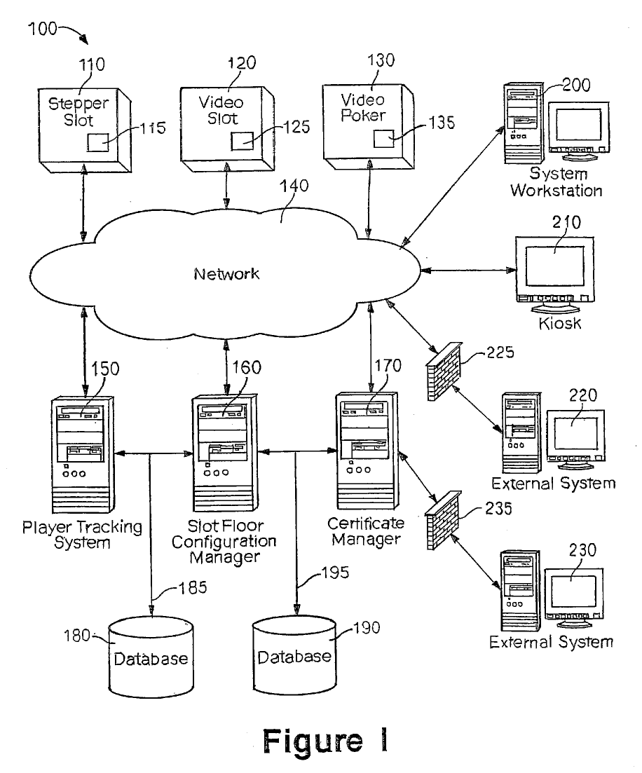

FIG. 1 illustrates a casino network system used in accordance with an embodiment of the present invention. Further details of a casino network system 100 may be found in WO 2007/014000, the disclosure of which is incorporated herein by reference. The embodiment provides a performance manager and associated performance management techniques to be employed in a system such as disclosed in WO 2007/014000.

Referring to FIG. 1, a casino network system 100 includes a plurality of gaming terminals 110, 120, and 130 interconnected through network 140 to a slot accounting and/or player tracking system 150 (hereinafter collectively referring to as a player tracking system), slot floor configuration manager 160 and certificate manager 170. It should be understood that, while FIG. 1 refers to configuring gaming terminals in the form of “slot machines” 100, 120 and video poker 120, other gaming terminals such as gaming tables for Blackjack, Pai Gow, Baccarat and others may be subject to reconfiguration where such tables are so adapted. As but an example, a gaming table layout may be embodied as a number of video displays, and reconfiguration may be of a type to reconfigure the video layout to change the game to be played at the table, bonus features, minimum and maximum bets and the like. Thus the term “gaming terminal” as used herein includes gaming tables as well. Person skilled in the art will also appreciate that some games such as stepper slots 110 may not be readily configurable because they are electro-mechanical in nature.

Player tracking system 150 and slot floor configuration manager 160 are connected to database server 180 via a communication link 185, which may be integrated with or separate from network 140. Slot floor configuration manager 160 and certificate manager 170 are connected to game database server 190 via a communication link 195 which may be integrated with or separate from network 140. In an embodiment, the casino network system 100 may be implemented in another gaming environment, such as a hotel, restaurant, theatre, store, airport or other venue having one or more gaming systems.

System 100 also includes a system workstation 200, connected to network 140. In addition, one or more self-service kiosks 210, and/or one or more external systems 220 may be connected to network 140. External system 220 is connected to network 140 through firewall 225, and may include a player terminal in a hotel room or other location external to the casino, for example. One or more kiosks 210 may be used to facilitate operations such as slot ticket redemption, player card point redemption, change and/or currency dispensation, promotion redemption and/or issuance, advertising, information, event and/or dining reservations and/or ticketing, etc. For example, one or more kiosks 210 and/or external systems 220 may used to purchase and/or view sports scores, news, game announcements, weather, flight information, show times, specials, reward tickets, prize tickets, coupons, airline or show tickets, reservation confirmation, or other information, for example. Additionally a player may be able to locate his or her favorite games, restaurants or other facilities and/or services at a kiosk 210.

Gaming terminals 110, 120, and 130 include smart communications interfaces (SCI) 115, 125, and 135 respectively, which communicate with network 140. In other embodiments, SCI 115, 125, and 135 may instead communicate with player tracking system 150 via other system and/or method, such as a serial communications protocol. In an embodiment, SCI 115, 125, and 135 may be integrated into a game controller for gaming terminals 110, 120, and 130.

Player tracking and slot accounting system 150 collects data from SCI 115, 125, and 135 for purposes of slot accounting, monitoring and security, and player tracking as is well known in the art. Player tracking system 150 processes and stores said data in database 180.

Slot floor configuration manager 160 receives information relevant to slot floor configuration management from player tracking system 150 and database 180. For example, slot floor configuration manager 160 may include an interface to player tracking system 150 to facilitate transfer of information between manager 160 and tracking system 150. In an embodiment, slot floor configuration manager 160 receives information from a database separate from database 180 used by player tracking system 150. In an embodiment, slot floor configuration manager 160 may receive floor configuration information independent of player tracking system 150, for example the slot floor configuration manager 160 also may receive information, including performance information such as coin-in, cash in, jackpots paid, coin-out and the like, directly from gaming terminal 110, 120, 130. Gaming terminals 110, 120, 130 may be connected to slot floor configuration manager 160 and/or player tracking system 150 via separate networks or a common network, such as an Ethernet.

Slot floor configuration manager 160 processes information to determine and/or suggest configurations of gaming terminals on a gaming floor, such as a casino floor. Slot manager 160 reviews, adjusts, and approves suggested floor configurations via system workstation 200. In an embodiment, players may be provided with an ability to select desired games to be downloaded to a terminal via SCI 115, 125, and 135 and/or gaming terminal 110, 120, and 130. Players may also review game information or update their profiles via kiosk 210 or external system 220, for example.

System 100 may also include external system 230, which is connected to certificate manager 170 via a dedicated, secure, communications link via firewall 235, for example. External system 230 may be a workstation in a gaming regulator's office, for example. Gaming regulators may monitor and manage game certificates on certificate manager 170 via external system 230. Unless required by a particular jurisdiction, the certificate manager 170 and associated equipment and functions may not be required.

Certificate manager 170 is configured to allow access to games to be controlled for a given gaming environment, such as governmental regulators or gaming operators acting in compliance with gaming regulations. The certificate manager 170 may work with a certificate database to control access to the game(s) being played. For example, the certificate database may include encoded and encrypted digital certificates or other authentication/license indicators that uniquely tie to games in the game database on a one-to-one basis. In an embodiment, due to the nature of the games and gaming terminals, a game may not be played unless a valid certificate for that game exists in the certificate database. In an embodiment, a certificate is also mated to a venue, such as a casino or other gaming environment, so that a game may not be played at another venue even if the game and certificate were electronically duplicated and moved to another venue.

In an embodiment, a certificate may also be mated to a binary image of a game file, such that a game may not be played if the binary image is modified. If a modification or update of a game image is a result of an authorized action, a new certificate may be issued by a regulator before the game may be played. Games lacking a valid certificate may be handled differently in a player's game catalog interface. In an embodiment, games lacking a valid certificate may be excluded from a player selection interface altogether. In an alternate embodiment, games lacking a valid certificate may be excluded from certain portions of a player catalog and/or visibly marked with an appropriate descriptive phrase such as “Pending approval for play in this casino”.

In an embodiment, certificates may be implemented such that the number of concurrently playing games of a given title may be limited by regulators or a game provider, for example. In an embodiment, certificates may be implemented such that a number of concurrently playing games from a given game provider is similarly limited. In an embodiment, the certificate database may be implemented to facilitate a total number of games being concurrently played at a given venue, if regulations enforce such a limit, for example.

In an embodiment, regulators have access to the certificate database, either through an interface local to a gaming environment or through a remote interface such as a web-based interface through a dedicated and encrypted network link between the venue and the regulator. Through this interface, the regulator may manage the certificate database to approve games for play or similarly revoke approval of games, for example.

In an embodiment, the casino floor configuration system 100 uses historical data as well as stored information regarding available games to determine and suggest, or in certain instances command, a game configuration or mix for the casino floor or other gaming environment. Such a mix may include, for example, game location(s), game denomination(s), game content, game appearance, terminal appearance, terminal operational mode and/or additional parameter(s) such as volatility, return to player (RTP), etc. In an embodiment, the system 100 may change a gaming environment floor configuration automatically. For example, rules, preferences, calendar-based schedules, and/or historical data may be used by system 100 to automatically reconfigure a gaming environment. As but a few examples, the denominations of games may be changed to higher denominations for periods such as holidays and weekends where tourists or conventioneers are expected and lower denominations during the week for local players. Where a large influx of tourists is expected, games may be converted from, for example, video poker games to video slot machine games which may be more popular with the expected demographics of the patrons. Historical data may also be used to control or suggest a configuration regime. Prior successful configurations may be accessed and duplicated and even tied to calendar events, e.g. reconfigure for the Christmas Holiday the same as last Christmas. Where players are entitled to select configurations, a historical record may be maintained with respect to player requested configurations and the same may be analyzed to set up configurations for the casino floor.

In an embodiment, the slot floor configuration manager 160 may include a workstation with an intuitive and easy-to-use interface, such as a visual representation of the casino floor with installed gaming terminals 110, 120, 130. For example, the workstation includes a display. The manager 160 controls the display to display the position of terminals on a casino floor and to display with each terminal (or group or banks of terminals) data or a visual reference corresponding to at least content then resident on each terminal (e.g. the current game or advertisements). For example, each terminal may be shown in association with at least one of a number, letter, label, icon and/or other indicator. As a specific example, each gaming terminal has associated therewith a graphic icon representing game content such as a representation of a unique game symbol, trademark, or other pictorial so an operator may determine at a glance a resident configuration of each terminal. Using a data input device such as a mouse, keyboard, remote control or touch screen, the operator may enter a prompt at a selected icon whereupon the processor is controlled to display further details such as denomination, performance, maintenance history, or the like. In this fashion, individual terminals or whole banks of terminals may be reconfigured intuitively, for example, in a “drag and drop” manner. The gaming terminals 110, 120, 130 may be selected individually and/or in groups for configuration changes, for example. In an embodiment, an operator and/or system may view and/or change gaming terminal 110, 120, 130 information and/or configuration using the configuration manager interface. Using the floor configuration manager 160, an operator may change a game available for play at a gaming terminal 110, 120, 130 and also information display via a primary and/or additional display at gaming terminal 110, 120, 130.

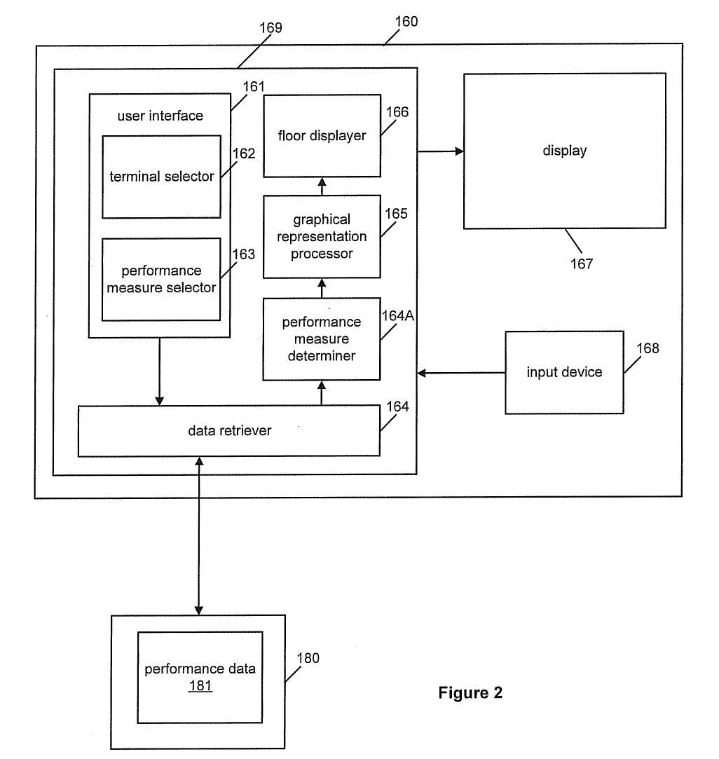

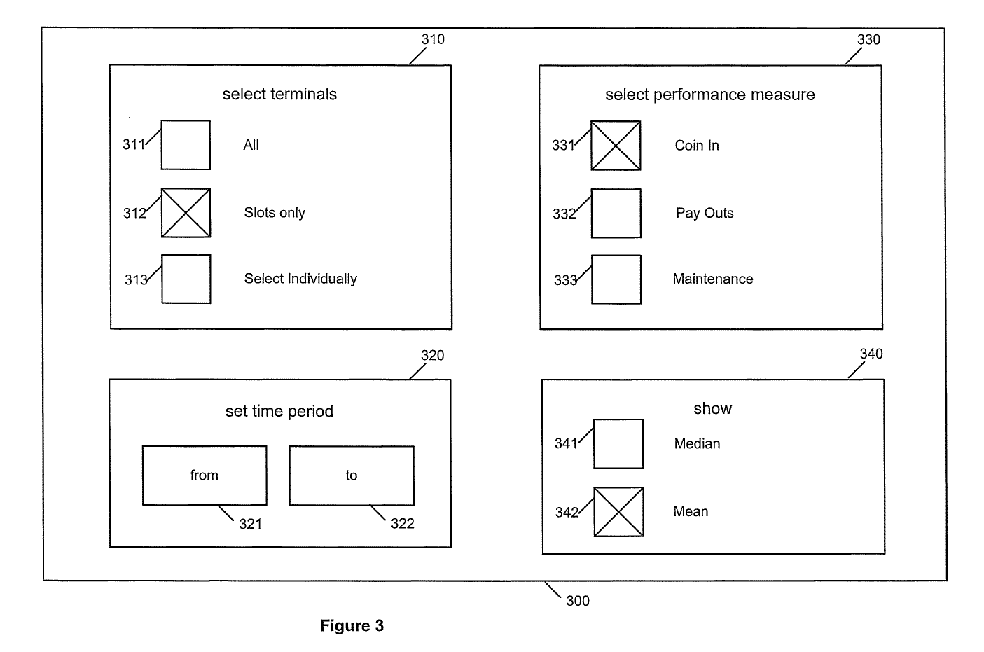

FIG. 2 illustrates the functional components of a performance manager of the slot configuration manager 160. The performance manager 169 has a number of user interface components 161 including a terminal selector 162 and a performance measure selector 163 operable by a player using an input device 168 in order to select the terminals in relation to which a performance measure is to be evaluated and to select one or more performance measures to be evaluated. Typically the options available to the user are displayed on display 167 and the input device 168 is in the form of the keyboard, mouse or the like in order to allow a player to make selections as will be described further in relation to FIG. 3. Once the player makes selections using the user interface components 161 a data retriever 164 retrieves the performance data 181 specified by the entered terminal selection and performance measure from database 180. The graphical representation processor 165 processes the performance measure data in order to produce a graphical representation of the performance measure for display on the display 167. Further, the performance manager 169 includes a floor displayer 166 that is configured to produce a display of the gaming floor or a portion of the gaming floor depending on parameters input by the user. In the embodiment, the floor displayer 166 displays a perspective view of the entire gaming floor based on data stored the database 180. The graphical representation processor 165 provides data to the floor display 166 which enables the floor displayer to overlay the graphical representation on the floor configuration display when it is displayed on the display 167.

Person skilled in the art will appreciate that while the above embodiment has been described from a functional perspective, the components of the performance manager 169 will typically be implemented as program code executed on a processor that forms part of the slot configuration manager. That is, the performance manager will typically be a software routine and each individual component a further sub-routine of the floor configuration manager. However, dedicated hardware realisations of the performance measure are also possible.

Person skilled in the art will appreciate that some features, for example graphical representation processor 165 or the floor displayer 166 may be used for other purposes by the slot configurator 160 and hence may be implemented in conjunction with the performance manager 169 rather than as part of the performance manager 169.

FIG. 3 illustrates an exemplary graphical user interface 300 which a player may operate using a pointing device such as a mouse. The user interface contains a plurality of areas. A first area 310 allows the player to select the terminals in relation to which a performance is to be displayed. It can be seen that the player has the options to select all terminals 311, slot machines only 312 or to select machines individually 313. The second area 320 allows the player to set the time period of the evaluation and contains a start period box 321 and end period box 322 which allows the player to specify time and date for the period of evaluation. In some embodiments, the player may also be allowed to set a hypothetical period, for example to show how a particular configuration is expected to perform in an upcoming holiday period. In this example, performance measure determiner 164A may determine a performance measure based on historical performance data or data obtained from another source, for example data from another venue.

A third area 330 allows the player to select the performance measure. In this example the player has three available performance measures including coin-in 331, payouts 332 and maintenance problems 333. The fourth area 340 allows the player to select how the measure should be represented, in this example as a median 341 or a mean 342.

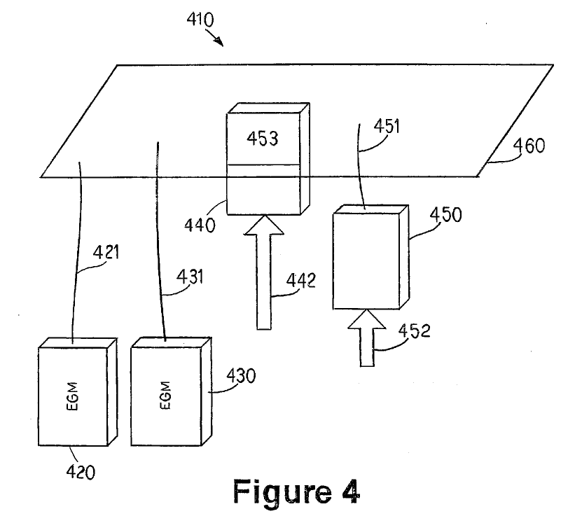

In an embodiment the graphical representation of data is displayed as a datum plane. In another embodiment the graphical representation may be as a line or similar. A datum plane is advantageous because it allows the performance to be overlaid on a perspective view of a gaming floor. This is illustrated schematically in FIG. 4. A casino floor configuration 410 is displayed having four electronic gaming machines (EGMs). For a casino having hundreds or thousands of gaming terminals, the floor configuration 410 would be a perspective view of all or a portion of the gaming floor preferable showing or at least representing the physical locations of the gaming machines. In this example, the floor configuration is modified by moving representations keyed to the gaming machines on the gaming floor relative to datum plane 460. For example, the casino operator may decide to compare the performance of the gaming machines on the floor based upon a calculated “floor average” hold percentage. This percentage would be calculated from the data received from the individual terminals on the gaming floor by, for example, the following equation:

Σwagers(t)−ΣJackpots Paid(t)/Σwagers(t)

where: Σwagers (t)=the sum of all wagers made at the gaming terminal for a time (t)

ΣJackpots Paid (t)=sum of all payouts from the gaming machine for the same time (t).

As but an example, if a gaming machine received $1000 in wagers for a 4 hour period and paid out $800 in jackpots, the hold percentage would be 20%, i.e. 1000−800/1000. The coin-in (wagers) for the gaming terminals as well as jackpots paid are constantly being monitored by the player tracking and slot accounting system 150 and thus the system can calculate for all machines a hold percentage as well as a floor average hold percentage, e.g.

ΣHold Percentage/No. of gaming terminals

This floor average hold percentage value would be represented in the display as a “ghost” or phantom datum plane over the gaming terminals shown in the perspective floor view. If the floor average is constantly being recalculated as machines become active and inactive it may be represented as moving vertically. A value of the floor average may be assigned and displayed relate to the datum, e.g. 83%.

According to the present invention In the example of FIG. 4, EGMs 420 and 430 are inactive and are merely shown with their position represented by lines 421 and 431 relative to the floor. Gaming machines 440 and 450 are active, as indicated by arrows 442 and 452 respectively. In the case of gaming machine 450, a line 451 is used to show the position relative to the datum plane 460 because the gaming machine's 450 performance is below the floor average. Gaming machine 440 is performing around the average and a line 453 through the representation of the EGM demonstrates where the EGM 440 intersects the datum plane 460. Accordingly it will be appreciated that the gaming machines are shown with their relative position to the desired performance measure.

While the display suggested in FIG. 4 shows representations of slot machines rising or falling relative to the datum plane 460, the system and method of the present invention could also use balloons, boxes or other icons graphically tied to the slot machines depicted in the display to represent relative performance. In this fashion, by a simple glance, an operator can determine which machines are underperforming, over-performing, and are providing average performance. The datum plane may be selected to be average coin-in for $0.25 machines in which case only $0.25 denomination machines would be graphically depicted relate to the datum. The datum could also segregate based upon floor average as well as by manufacturer in which case only the selected manufacturer(s) machines would be depicted relative to the datum.

Based upon historical data the operator can also compare to selected parameters, e.g. best hold percentage in the last month, to graphically see how gaming machines are now or in the past performed relative to the selected parameter. In yet a further feature, manufacturers can provide the operator with empirical data relative to their machines/games to see, hypothetically, how these games would later floor average (i.e. the datum) and perform relative to the datum. In this fashion an operator can determine whether purchase of the machine/game would enhance profitability.

It will be appreciated that the position of the active machines or alternatively the selected machines relative to the floor tells the operator how machines or banks of machines are performing. Further, over time the data may shift up or down and machines will float up to or through the datum 460, drop below the datum 460 so the operator has a real-time graphical representation of performance. As discussed in WO2007/014000, a player can select an individual machine to obtain detail about that machine.

Person skilled in the art will appreciate that a number of performance measures other than those discussed before could be used. For example, an example of a maintenance parameter would be “tilts” of the machine. For example, in respect of table games the gross amount held per unit time, i.e. the total wagered minus the total paid out may be displayed.

Person skilled in the art will appreciate that historical analysis can be made. For example, a first datum plain may show the current performance whereas a second datum plane may show performance at a peak time. The performance manager could be used to view how performance compares to a different number of configuration, for example, if banks of gaming machines are moved relative to the floor or different games are downloaded to the gaming machines.

An advantage of certain of the above embodiments is that performance can be seen relative to the floor configuration.

An advantage of certain of the above embodiments is that performance is displayed in a manner in which it can be interpreted intuitively.

Person skilled in the art will appreciate that various other modification may be made to the foregoing embodiment without departing from the scope of the invention. These and other modifications should be considered as falling within the scope of the invention defined in the attached claims. In particular, it should be apparent that features of various of the above embodiments and examples can be combined to produce further embodiments.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of displaying performance data in a gaming system, the method comprising:
deriving at least one performance measure from at least one performance parameter of each of a plurality of gaming terminals;
graphically representing the performance measure on a display; and
displaying a representation of the performance of each gaming terminal relative to the graphically represented performance measure, the representation based on the at least one performance parameter of the gaming terminal.

2. A method as claimed in claim 1, further comprising displaying a floor configuration of the plurality of gaming machines such that the graphical representation of the performance measure is displayed in the context of the floor configuration.

3. A method as claimed in claim 2, wherein the floor configuration is displayed as a perspective view.

4. A method as claimed in claim 3, wherein graphically representing the performance measure comprises representing the performance measure as a datum plane such that the performance of each gaming terminal is represented relative to the datum plane.

5. A method as claimed in claim 4, wherein displaying a representation of the performance of each gaming terminal relative to the datum plane comprises displaying a performance indicator for each gaming terminal relative to the plane.

6. A method as claimed in claim 4, wherein displaying a representation of the performance of each gaming terminal relative to the datum plane comprises displaying a representation of the gaming terminal relative to the datum plane to thereby represent the performance of each gaming terminal.

7. A method as claimed in claim 6, wherein each representation is linked to the display of the gaming machine in the floor configuration display of the plurality of gaming machines.

8. A method as claimed in claim 6, further comprising altering the floor configuration display of the plurality of gaming terminals so as to move the display of at least some of the gaming terminals relative to the datum plane.

9. A method as claimed in claim 1, comprising deriving a value of a performance parameter for at least one of the plurality of gaming terminals from historical data for the performance parameter.

10. A method as claimed in claim 1, comprising deriving a predicted value of a performance parameter for at least one of the plurality of gaming terminals.

11. A performance manager for a gaming system arranged to:
derive at least one performance measure from at least one performance parameter of each of a plurality of gaming terminals;
generate a graphical representation of the performance measure for output to a display; and
generate a display of a representation of the performance of each gaming terminal relative to the graphically represented performance measure for output to the display, the representation based on the at least one performance parameter of the gaming terminal.

12. A performance manager as claimed in claim 11, further arranged to generate a display of a floor configuration of the plurality of gaming machines such that the graphical representation of the performance measure is displayed in the context of the floor configuration.

13. A performance manager as claimed in claim 12, wherein the floor configuration is displayed as a perspective view.

14. A performance manager as claimed in claim 12, wherein the performance measure is represented as a datum plane superimposed on the display of the floor configuration.

15. A performance manager as claimed in claim 14, arranged to display a performance indicator for each gaming terminal in order to represent the performance of each gaming terminal relative to the datum plane.

16. A performance manager as claimed in claim 14, arranged to display a representation of the machine relative to the datum plane in order to represent the performance of each gaming terminal relative to the datum plane.

17. A performance manager as claimed in claim 16, wherein each representation is linked to the display of the gaming machine in the floor configuration display of the plurality of gaming machines.

18. A performance manager as claimed in claim 16, further arranged to alter the floor configuration display of the plurality of gaming terminals so as to move the display of at least some of the gaming terminals relative to the datum plane.

19. A performance manager as claimed in claim 11 arranged to derive a value of a performance parameter for at least one of the plurality of gaming terminals from historical data for the performance parameter.

20. A performance manager as claimed in claim 11 arranged to derive a predicted value of a performance parameter for at least one of the plurality of gaming terminals.

21. A performance manager as claimed in claim 11 comprising a processor and a memory and implemented, at least in part, by the processor executing program code stored in the memory.

22. A performance management system for a gaming system comprising:
a display; and
a performance manager arranged to:
derive at least one performance measure from at least one performance parameter of each of a plurality of gaming terminals;
generate a graphical representation of the performance measure for display on the display; and
generate a display of a representation of the performance of each gaming terminal relative to the graphically represented performance measure, the representation based on the at least one performance parameter of the gaming terminal.

23. A performance management system as claimed in claim 22 comprising a user interface arranged to allow a user to select at least one performance parameter from which the performance measure is to be derived.

24. A performance management system as claimed in claim 22 comprising a user interface arranged to allow a user to select a plurality of gaming terminals in relation to which the performance measure is to be derived.

25. A performance management system as claimed in claim 22, wherein the performance manager is further arranged to generate a display of a floor configuration of the plurality of gaming machines such that the graphical representation of the performance measure is displayed in the context of the floor configuration.

26. A performance management system as claimed in claim 25, wherein the performance manager floor configuration is displayed as a perspective view.

27. A performance management system as claimed in claim 26, wherein the performance measure is represented as a datum plane.

28. A performance management system as claimed in claim 27, wherein the performance manager is further arranged to display a performance indicator for each gaming terminal in order to represent the performance of each gaming terminal relative to the datum plane.

29. A performance management system as claimed in claim 27, wherein the performance manager is further arranged to display a representation of the machine relative to the datum plane in order to represent the performance of each gaming terminal relative to the datum plane.

30. A performance management system as claimed in claim 29, wherein each representation is linked to the display of the gaming machine in the floor configuration display of the plurality of gaming machines.

31. A performance management system as claimed in claim 29, wherein the performance manager is further arranged to alter the floor configuration display of the plurality of gaming terminals so as to move the display of at least some of the gaming terminals relative to the datum plane.

32. A performance management system as claimed in claim 22, wherein the performance manager is arranged to derive a value of a performance parameter for at least one of the plurality of gaming terminals from historical data for the performance parameter.

33. A performance management system as claimed in claim 22, wherein the performance manager is to derive a predicted value of a performance parameter for at least one of the plurality of gaming terminal.

34. A performance management system as claimed in claim 22, wherein the performance manager comprises a processor and a memory and is implemented, at least in part, by the processor executing program code stored in the memory.

35. Computer program code which when executed by a computer causes the computer to implement a computer implemented performance management method comprising:
deriving at least one performance measure from at least one performance parameter of each of a plurality of gaming terminals;
graphically representing the performance measure on a display; and
displaying a representation of the performance of each gaming terminal relative to the graphically represented performance measure, the representation based on the at least one performance parameter of the gaming terminal.

36. A computer readable medium having thereon the computer program code of claim 35.

37. Transmitting the program code of claim 35.
